(19) United States
(12) Patent Application Publication
(10) Pub. No.: US 2018/0368391 A1
(43) Pub. Date: Dec. 27, 2018

(54) Turkey Call

(71) Applicant: Steven Scott Ward, Fredericktown, MO (US)

(72) Inventor: Steven Scott Ward, Fredericktown, MO (US)

(21) Appl. No.: 15/998,052

(22) Filed: Jun. 19, 2018

Related U.S. Application Data
(60) Provisional application No. 62/604,075, filed on Jun. 22, 2017.

(51) Int. Cl. A01M 31/00

(52) U.S. Cl. CPC A01M 31/004

(57) ABSTRACT

A turkey call, including: (a) a first sheet of a material; (b) a second sheet of a material; (c) a first spacer; (d) a second spacer; and (e) a third spacer; the plane of the first sheet of material being spaced apart from the plane of the second sheet of material with the first, second and third spacers positioned between the first and second sheets of material so that opposite edges of the first and second sheets of material are attached to the first, second and third spacers to define an open mouthed cavity between the first and second sheets of material and the first, second and third spacers, wherein the first and second sheets of material are selected from the group consisting of stainless steel and brass, stainless steel and slate or brass and aluminum.

### BACKGROUND OF THE INVENTION

The instant invention relates to a device for simulating the mating, gathering, and feeding calls of wild turkeys. Heretofore, devices have been proposed for simulating the calls of the wild turkey. One type of turkey call is the slate box call comprising a flat sheet of slate mounted on a box and a striking stick. The slate box is held in one hand while the stick is held in the other. The stick is brought into contact with the slate in short strokes to simulate the calls of the wild turkey. The box provides an acoustic chamber for the call sound. Many advances have been to slate box turkey calls. For example, U.S. Pat. No. 5,178,575 discloses a slate box turkey call having both a sheet of glass and a sheet of slate for producing a wider variety of different calls. Despite the many advances in the art of slate box turkey calls comprising different sound producing materials, there remains a need for the discovery of even more improved turkey calls.

### SUMMARY OF THE INVENTION

The instant invention is the discovery of a new and improved slate box type of turkey call. The turkey call of the instant invention is comprised of: (a) a first sheet of a material; (b) a second sheet of a material; (c) a first spacer; (d) a second spacer; and (e) a third spacer; the plane of the first sheet of material being spaced apart from the plane of the second sheet of material with the first, second and third spacers positioned between the first and second sheets of material so that opposite edges of the first and second sheets of material are attached to the first, second and third spacers to define an open mouthed cavity between the first and second sheets of material and the first, second and third spacers, wherein the first and second sheets of material are selected from the group consisting of stainless steel and brass, stainless steel and slate or brass and aluminum.

### BRIEF DESCRIPTION OF THE DRAWINGS

FIGS. 1a and 1b depict perspective views of both sides of a highly preferred embodiment of the instant invention;

FIGS. 2a and 2b are top and end views of the embodiment shown in FIG. 1 and include dimensions in inches; and

FIGS. 3a and 3b depict perspective views of each end of the embodiment shown in FIG. 1.

### DETAILED DESCRIPTION OF THE INVENTION

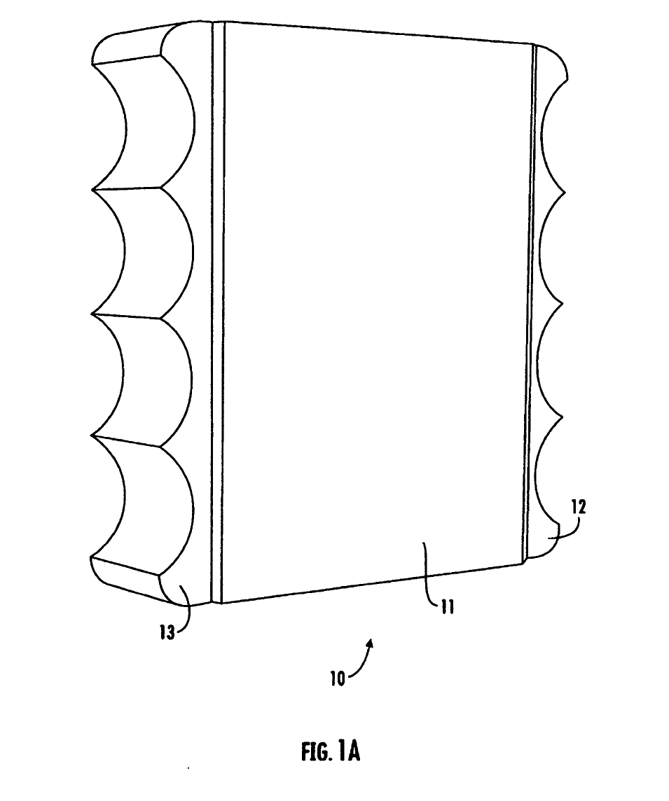

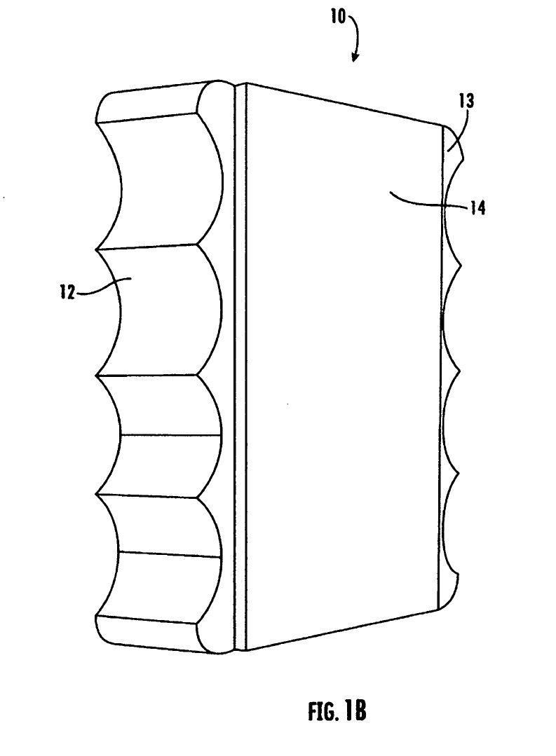

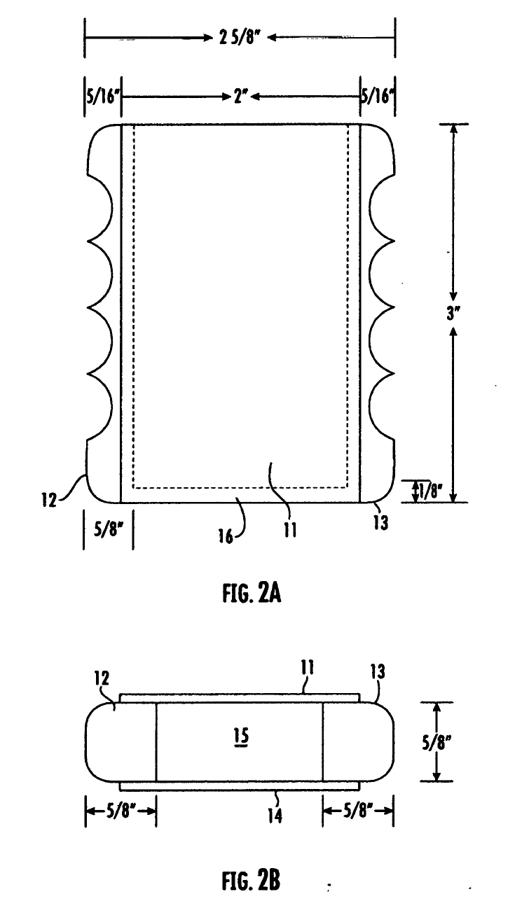

Referring now to FIGS. 1a and 1b therein is shown perspective views of both sides of a highly preferred embodiment 10 of the instant invention. The embodiment 10 includes first sheet of aluminum 11, second sheet of brass 14, first spacer 12, and second spacer 13. Referring now to FIGS. 2a and 2b therein is shown top and end view of the embodiment 10 shown in FIGS. 1a and 1b and includes dimensions in inches as well as third spacer 16 and open mouther cavity 15. Referring now to FIGS. 3a and 3b therein is shown perspective views of both ends of the embodiment 10 shown in FIGS. 1a and 1b including third spacer 16 and open mouthed cavity 15.

In use a striking stick is rubbed on the first sheet of material or on the second sheet of material of the instant invention to produce a turkey call sound resonated by the open mouthed cavity. The open mouth of the cavity can be pointed in different directions to simulate the sound of an approaching or a retreating turkey. The material of construction of the first and second sheets of material is critical in the instant invention. The first and second sheets of material can be stainless steel and brass respectively or stainless steel and slate respectively or brass and aluminum respectively. Each of these three combinations provides a hunter with a versatile call by striking a selected side of the call with a stick. When the plane of the these specific first and second sheets are spaced apart in a construction that provides an open mouthed resonant cavity, a turkey call is produced with surprisingly superior acoustic performance for simulating the mating, gathering, and feeding calls of wild turkeys. The best utility of the instant invention is obtained when a hunter has all three embodiments in his/her kit when hunting wild turkeys. The material of construction of the spacers can be any suitable material but preferably the spacers are wood. The dimensions shown in FIG. 2 are highly preferred but not critical in the instant invention. The term “stainless steel” means a steel alloy of any temper comprising a minimum of 10 weight percent chromium. The term “aluminum” means an aluminum alloy of any temper comprising a minimum of 80 weight percent aluminum. The term “brass” means an alloy of any temper primarily comprising zinc and copper. The term “slate” means a foliated metamorphic rock.

### CONCLUSION

While the instant invention has been described above according to its preferred embodiments, it can be modified within the spirit and scope of this disclosure. This application is therefore intended to cover any variations, uses, or adaptations of the instant invention using the general principles disclosed herein. Further, the instant application is intended to cover such departures from the present disclosure as come within the known or customary practice in the art to which this invention pertains.

What is claimed is:

1. A turkey call, comprising: (a) a first sheet of a material; (b) a second sheet of a material; (c) a first spacer; (d) a second spacer; and (e) a third spacer; the plane of the first sheet of material being spaced apart from the plane of the second sheet of material with the first, second and third spacers positioned between the first and second sheets of material so that opposite edges of the first and second sheets of material are attached to the first, second and third spacers to define an open mouthed cavity between the first and second sheets of material and the first, second and third spacers, wherein the first sheet of material is a sheet of stainless steel while the second sheet of material is a sheet of brass.

2. A turkey call, comprising: (a) a first sheet of a material; (b) a second sheet of a material; (c) a first spacer; (d) a second spacer; and (e) a third spacer; the plane of the first sheet of material being spaced apart from the plane of the second sheet of material with the first, second and third spacers positioned between the first and second sheets of material so that opposite edges of the first and second sheets of material are attached to the first, second and third spacers to define an open mouthed cavity between the first and second sheets of material and the first, second and third spacers, wherein the first sheet of material is a sheet of stainless steel while the second sheet of material is a sheet of slate.

3. A turkey call, comprising: (a) a first sheet of a material; (b) a second sheet of a material; (c) a first spacer; (d) a second spacer; and (e) a third spacer; the plane of the first sheet of material being spaced apart from the plane of the second sheet of material with the first, second and third spacers positioned between the first and second sheets of material so that opposite edges of the first and second sheets of material are attached to the first, second and third spacers to define an open mouthed cavity between the first and second sheets of material and the first, second and third spacers, wherein the first sheet of material is a sheet of brass while the second sheet of material is a sheet of aluminum.
